(19) United States
(12) Patent Application Publication
(10) Pub. No.: US 2026/0352315 A1
(43) Pub. Date: Nov. 5, 2026

(54) SECURE WIRELESS SIGNAL TRANSMISSION METHOD USING SUBARRAY-BASED FREQUENCY DIVERSE ARRAY AND COMPUTING DEVICE PERFORMING THE SAME

(71) Applicant: University-Industry Cooperation Group of Kyung Hee University, Gyeonggi-do (KR)

(72) Inventors: HAEJOON JUNG, Gyeonggi-do (KR); BYUNGHA YOU, Incheon (KR); JIJUN HWANG, Gyeonggi-do (KR); DONGHYEON KIM, Gyeonggi-do (KR); SUNGHOON SHIM, Gyeonggi-do (KR)

(21) Appl. No.: 19/300,912

(22) Filed: Aug. 15, 2025

(30) Foreign Application Priority Data
May 2, 2025 (KR) 10-2025-0058462

(51) Int. Cl. H04B 7/12; H04B 7/0456

(52) U.S. Cl. CPC H04B 7/12; H04B 7/0456

(57) ABSTRACT

A method for wireless signal transmission using a subarray-based frequency diverse array includes configuring a frequency offset for each of subarrays, determining a transmission frequency for antenna elements included in each of the subarrays based on the frequency offset, setting some of the subarrays as a first transmission group and transmitting a matching signal so that phases of signals of the subarrays included in the first transmission group are matched at a position of a receiver, setting the remaining subarrays not included in the first transmission group among the subarrays as a second transmission group and transmitting an interference signal so that signals of the subarrays included in the second transmission group induce a random interference effect at a position of an eavesdropper, and combining the matching signal and the interference signal and transmitting the combined signal to a terminal of the receiver.

### CROSS-REFERENCE TO RELATED APPLICATION AND CLAIM OF PRIORITY

This application claims the benefit under 35 USC § 119 (a) of Korean Patent Application No. 10-2025-0058462, filed on May 2, 2025, in the Korean Intellectual Property Office, the entire disclosure of which is incorporated herein by reference for all purposes.

### BACKGROUND

### 1. Field

The present disclosure relates to a field of wireless communication technology, and more particularly, to a wireless signal transmission method that enhances the security of a transmission signal.

### 2. Description of Related Art

In existing wireless communication systems, various beamforming technologies have been used to intensively transmit signals to receivers in a specific direction or distance. In particular, the frequency diverse array (FDA) technology that can consider both direction and distance information has the advantage of being advantageous in terms of security and transmission performance improvement compared to the traditional phased array.

However, in the existing method using the frequency diverse array, there was a problem that the transmission signals could be distributed relatively evenly at positions outside a receiver, and thus the signals could be leaked to an eavesdropper. Accordingly, a method of designing transmission signals to be divided into matching and interference signals so that the signals are matched at the receiver's position and interference occurs at the eavesdropper's position has been required.

Examples of related art include Korean Unexamined Patent Application Publication Number 10-2012-0086497.

### SUMMARY

The present disclosure aims to improve the security of wireless signals by randomly setting up a transmission group based on a plurality of subarray and configuring transmission signals to generate a phase-matched signal at a receiver position and induce an interference signal at an eavesdropper position to allow high reception quality to be maintained at the receiver position and allow communication quality to be degraded at the eavesdropper position. In addition, the present disclosure aims to simultaneously improve the security and efficiency of the wireless communication system by maximizing a secrecy rate through transmission frequency setting and transmission group division.

As a means for achieving the above-described technical problem, according to an aspect of the present disclosure, the above-described means for solving the problem are merely exemplary and should not be construed as limiting the present disclosure. In addition to the exemplary embodiments described above, there may be additional embodiments described in the drawings and the detailed description of the invention.

According to an aspect of the present disclosure, there is provided a wireless signal transmission method using a subarray-based frequency diverse array (FDA), the wireless signal transmission method including configuring a frequency offset for each of a plurality of subarrays based on a reference frequency, determining a transmission frequency for a plurality of antenna elements included in each of the subarrays based on the frequency offset, setting some of the plurality of subarrays as a first transmission group and transmitting a matching signal so that phases of signals of the subarrays included in the first transmission group are matched at a position of a receiver, setting the remaining subarrays not included in the first transmission group among the plurality of subarrays as a second transmission group and transmitting an interference signal so that signals of the subarrays included in the second transmission group induce a random interference effect at a position of an eavesdropper, and combining the matching signal and the interference signal and transmitting the combined signal to a terminal of the receiver.

In the aspect of the present disclosure, the subarray is comprised of a plurality of antenna blocks arranged in a grid shape in the x-axis and y-axis directions on a two-dimensional plane.

In the aspect of the present disclosure, the frequency offset is configured based on a position of the subarray, and the configuring of the frequency offset follows a distribution of at least one of a logarithmic function, a window function, or a trigonometric function among non-uniform frequency offset configuration methods.

In the aspect of the present disclosure, the transmission frequency is determined by adding a correction term according to the frequency offset value set according to a position of a subarray in the x-axis direction and a position index of an antenna element in the x-axis direction within the subarray, and a correction term according to the frequency offset value set according to a position of a subarray in the y-axis direction and a position index of a y-axis direction antenna element within the subarray, respectively, based on the reference frequency.

In the aspect of the present disclosure, the transmission frequency is determined by Equation below.

$${f}_{\text{?}}^{\text{?}} = {f}_{\text{?}} + {Δ}_{\text{?}} {χ}_{\text{?}} + {\tilde{Δ}}_{\text{?}} {\tilde{χ}}_{\text{?}} \qquad [ Equation ]$$

$$\text{?} \text{indicates text missing or illegible when filed}$$

$${f}_{\text{?}}^{\text{?}} :$$

$$\text{?} \text{indicates text missing or illegible when filed}$$

transmission frequency of (nₓ,n_{y})-th antenna element within (mₓ,m_{y})-th subarray:
f_{c}: reference frequency of entire frequency diverse array (FDA);
Δₘ_{_{z}}: unit value of x-direction frequency offset set according to x-axis direction subarray position m_{z}
χₙ_{ₓ}: position index of x-axis direction antenna element within subarray:
\tilde{Δ}ₘ_{_{y}}: unit value of y-direction frequency offset set according to position of subarray in the y-axis direction \tilde{χ}ₙ_{_{y}}: position index of y-axis direction antenna element within subarray.

In the aspect of the present disclosure, the first transmission group is subjected to precoding so that phases are matched at the position of the receiver, and the second transmission group is set to transmit the interference signal.

In the aspect of the present disclosure, the antennas of the first transmission group are randomly selected for each signal cycle, and the antennas of the first transmission group are subjected to precoding so that phases are aligned at the position of the receiver.

In the aspect of the present disclosure, the transmission signal is set with a precoding weight for each transmission period corresponding to the position of the receiver for each of the plurality of antenna elements constituting the subarray, for each of the subarrays included in the first transmission group and the subarrays included in the second transmission group, and the precoding weight is set to reflect a phase delay based on a spatial position of each antenna element and a range, azimuth, and elevation of the receiver.

In the aspect of the present disclosure, the subarray included in the first transmission group is subjected to precoding so that phases are matched at the position of the receiver for each of the antenna elements constituting the subarray, and the precoding weight applied to the antenna element is set according to Equation below.

$${v}_{l} ( κ ) = \frac{1}{\sqrt{L}} {e}^{j {Υ}_{\text{?}}^{\text{?}} ( {r}_{B} , {ϕ}_{B} , {θ}_{B} )} \qquad [ Equation ]$$

$$\text{?} \text{indicates text missing or illegible when filed}$$

for (mₓ,m_{y})∈ first transmission group
υₗ(κ): precoding weight applied to l-th antenna belonging to first transmission group in transmission period κ
κ: index of transmission period in which the current transmission is performed
L: number of transmitting antennas or subarrays included in first transmission group

$${Υ}_{\text{?}}^{\text{?}} ( {r}_{B} , {ϕ}_{B} , {θ}_{B} ) :$$

$$\text{?} \text{indicates text missing or illegible when filed}$$

phase delay at receiver position (r_{B},φ_{B},θ_{B}) according to the subarray position (mₓ,m_{y}) and antenna element position (nₓ,n_{y}) within corresponding subarray
mₓ,m_{y}: position indices of subarrays arranged in x-axis and y-axis directions
nₓ,n_{y}: position indices of individual antenna elements within each subarray
r_{B}: range coordinate of receiver:
φ_{B}: azimuth angle of receiver
θ_{B}: elevation angle of receiver.

In the aspect of the present disclosure, the subarray included in the second transmission group is subjected to precoding so that the phase is inverted by π is cancelled out by the matching signal for each antenna element constituting the subarray, and the precoding weight applied to the subarray is set according to Equation below.

$${v}_{l} ( κ ) = \frac{1}{\sqrt{L}} {e}^{j ( {Υ}_{\text{?}}^{\text{?}} ( {r}_{B} , {ϕ}_{B} , {θ}_{B} ) + π )} \qquad [ Equation ]$$

$$\text{?} \text{indicates text missing or illegible when filed}$$

for (mₓ,m_{y})∈ second transmission group
υₗ(κ): precoding weight applied to l-th antenna belonging to second transmission group in transmission period κ
κ: index of transmission period in which the current transmission is performed:
L: number of transmitting antennas or subarrays included in second transmission group

$${Υ}_{\text{?}}^{\text{?}} ( {r}_{B} , {ϕ}_{B} , {θ}_{B} ) :$$

$$\text{?} \text{indicates text missing or illegible when filed}$$

phase delay at receiver position (r_{B},φ_{B},θ_{B}) according to the subarray position (mₓ,m_{y}) and antenna element position (nₓ,n_{y}) within corresponding subarray:
mₓ,m_{y}: position indices of subarrays arranged in x-axis and y-axis directions
nₓ,n_{y}: position indices of individual antenna elements within each subarray
r_{B}: range coordinate of receiver
φ_{B}: azimuth angle of receiver:
θ_{B}: elevation angle of receiver.

In the aspect of the present disclosure, the matching signal and the interference signal are synchronized in the same time and frequency band and transmitted in a linear combination manner.

In the aspect of the present disclosure, a secrecy rate is calculated by Equation below.

η=[ log₂(1+γ_{B})−log₂(1+γ_{E})]⁺ [Equation]
η: secrecy rate, which represents secure transmission rate at which receiver can recover information and eavesdropper cannot recover information
γ_{B}: received signal-to-noise ratio (SNR) or signal-to-interference-noise ratio (SINR) of receiver
γ_{E}: received signal-to-noise ratio (SNR) or signal-to-interference-noise ratio (SINR) of eavesdropper
[⋅]⁺: positive part, which returns 0 if value in square brackets is less than 0, and returns value as is if it is greater than or equal to 0.

In the aspect of the present disclosure, a combination of the frequency offset value and antenna selection of the subarray is optimized so that the secret rate is maximized based on Equation below.

$$η = {[ {log}_{2} ( 1 + \frac{PN}{{σ}^{2} {r}_{B}^{2}} \cdot \frac{{( 2 {M}_{\text{?}} - M )}^{2}}{M} ) - {log}_{2} ( 1 + \frac{\frac{P}{\text{?} \sqrt{L}} \cdot \frac{2 {M}_{\text{?}} - M}{M} \cdot {\vert Λ \vert}^{2}}{\frac{4 P}{\text{?} L} \cdot \frac{{M}_{\text{?}} ( M - {M}_{\text{?}} )}{M ( M - 1 )} ( \tilde{Λ} - \frac{1}{M} {\vert Λ \vert}^{2} ) + {σ}^{2}} ) ]}^{+} \qquad [ Equation ]$$

$$\text{?} \text{indicates text missing or illegible when filed}$$

η: secrecy rate, which represents secure transmission rate at which receiver can recover information and eavesdropper cannot recover information
P: transmission power
N: number of antennas included in receiving device of receiver
σ²: power of background noise
r_{B}: distance from transmitting antenna to receiver r_{E}: distance from transmitting antenna to eavesdropper
M: number of total subarrays (or transmitting antennas)
Mₛ: number of subarrays included in first transmission group (matching signal group)
L: normalization factor considered when combining matching signals
   |Λ|²: magnitude of square of sum of phase-aligned signals at receiving position
\tilde{Λ}: total sum of power of all transmission signals arriving at receiving position
[⋅]⁺: positive part, which returns 0 if value in square brackets is less than 0, and returns value as is if it is greater than or equal to 0.

According to another aspect of the present disclosure, there is provided a computing device including a plurality of subarrays arranged in a grid shape in the x-axis and y-axis directions on a two-dimensional plane, each subarray being comprised of antenna blocks arranged in a grid shape in the x-axis and y-axis directions on a two-dimensional plane, a processor, and a memory storing one or more programs executed by the processor, in which the processor is configured to perform an operation of configuring a frequency offset for each of the plurality of subarrays based on a reference frequency, an operation of determining, for a plurality of antenna elements included in each of the subarrays, a transmission frequency of the antenna element based on the frequency offset, an operation of setting some of the plurality of antennas as a first transmission group and transmitting a matching signal so that a phase of a signal of the antenna included in the first transmission group is matched at a position of a receiver, an operation of setting the remaining antennas not included in the first transmission group among the plurality of subarrays as a second transmission group and transmitting an interference signal so that a signal of the antenna included in the second transmission group induces a random interference effect at a position of an eavesdropper, and an operation of combining the matching signal and the interference signal and transmitting the combined signal to a terminal of the receiver.

According to still another aspect of the present disclosure, there is provided a computer program stored in a non-transitory computer readable storage medium, in which the computer program includes one or more instructions, and the instructions, when executed by a computing device including one or more processors, cause the computing device to perform configuring a frequency offset for each of a plurality of subarrays based on a reference frequency, determining, for a plurality of antenna elements included in each of the subarrays, a transmission frequency of the antenna element based on the frequency offset, setting some of the plurality of antennas as a first transmission group and transmitting a matching signal so that a phase of a signal of the antenna included in the first transmission group are matched at a position of a receiver, setting the remaining antennas not included in the first transmission group among the plurality of subarrays as a second transmission group and transmitting an interference signal so that a signal of the antenna included in the second transmission group induces a random interference effect at a position of an eavesdropper, and combining the matching signal and the interference signal and transmitting the combined signal to a terminal of the receiver.

### BRIEF DESCRIPTION OF THE DRAWINGS

The accompanying drawings below, which are used for the description of the embodiments of the present disclosure, are only a part of the embodiments of the present disclosure, and other drawings may be obtained based on these drawings without any effort to come up with a new invention by those skilled in the art to which the present disclosure belongs (hereinafter referred to as “a person of ordinary skill”).

FIG. 1 is a flowchart for describing a frequency offset-based wireless signal transmission procedure according to an embodiment of the present disclosure.

FIG. 2 is a diagram showing a planar frequency diverse array (FDA)-based transmitter configuration according to an embodiment of the present disclosure.

FIG. 3 is a block diagram showing a frequency offset configuration method according to an embodiment of the present disclosure, and structurally presents various methods for configuring a frequency offset based on a mathematical function.

FIG. 4 is a flowchart illustrating a procedure for optimizing a secrecy rate according to an embodiment of the present disclosure.

FIGS. 5A to 5D are drawings showing three-dimensional radiation patterns formed according to various frequency offset configuration methods according to an embodiment of the present disclosure.

FIG. 6 is a block diagram showing a configuration of a computing device that performs secure wireless signal transmission using a subarray-based frequency diverse array according to an embodiment of the present disclosure.

### DETAILED DESCRIPTION

The following detailed description is provided to aid in a comprehensive understanding of the methods, devices and/or systems described herein. However, this is only an example and the present disclosure is not limited thereto.

In describing embodiments of the present disclosure, when it is determined that a detailed description of a known technology related to the present disclosure may unnecessarily obscure the gist of the present disclosure, the detailed description thereof will be omitted. In addition, the terms described below are terms defined in consideration of their functions in the present disclosure and may vary depending on the intention or custom of the user or operator. Therefore, the definition should be made based on the contents throughout this specification. The terms used in the detailed description are only for describing embodiments of the present disclosure and should not be considered limiting. Unless clearly used otherwise, expressions in the singular form include the meaning of the plural form. In this description, expressions such as “including” or “comprising” are intended to indicate certain features, numbers, steps, operations, elements, parts or combinations thereof, and should not be construed to exclude the presence or possibility of one or more other features, numbers, steps, operations, elements, parts or combinations thereof other than those described.

In addition, terms such as first, second, etc. may be used to describe various components, but the components should not be limited by the terms. Terms may be used for the purpose of distinguishing one component from another. For example, without departing from the scope of the present disclosure, a first component may be referred to as a second component, and similarly, a second component may also be referred to as a first component.

Hereinafter, embodiments of the present disclosure will be described in detail with reference to the drawings attached to this specification.

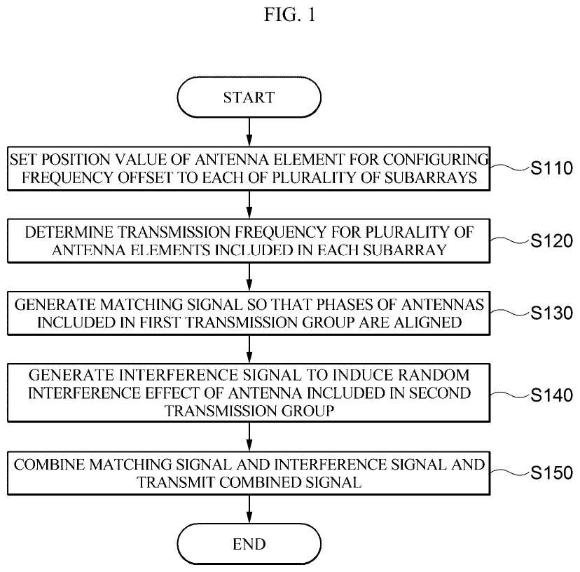

FIG. 1 is a flowchart for describing a frequency offset-based wireless signal transmission procedure according to an embodiment of the present disclosure. The present disclosure may improve security by using an antenna array comprised of a plurality of subarrays to divide a transmission signal into a matching signal and an interference signal, linearly combine the signals, and stably transmit the combined signal to a receiver while inducing random interference to an eavesdropper.

The frequency diverse array (FDA) is an antenna technology that creates a radiation pattern that is simultaneously adjustable in distance and direction by assigning different transmission frequencies (offset frequencies) to respective elements of the antenna array. Unlike a conventional phased array, the frequency diverse array may enable precise beam adjustment and secure communication based on time, space, and distance by using an additional degree of freedom called frequency offset.

A subarray index may mean a unique number assigned to distinguish each subarray when the entire antenna array (FDA) s divided into several small subsets. In addition, an antenna element index may mean a unique number for identifying individual antenna elements arranged within a subarray.

In addition, the main lobe refers to the direction in which the antenna sends the strongest signal, and the side lobes refer to signals that spread weakly in directions outside the main lobe.

Symbol data mean unit data obtained by converting information to be transmitted into physical signals through modulation in digital communication.

Beamforming is a technology that uses multiple antennas to strongly focus signals in one direction, and precoding is a technology that adjusts the magnitude and phase of the signal to be sent to each antenna in advance to make beamforming smarter.

First, in step S110, a position value of an antenna element for configuring a frequency offset to each of a plurality of subarrays may be calculated. The subarray may be comprised of a plurality of antenna blocks arranged in a grid shape in the x-axis and y-axis directions on a two-dimensional plane. Therefore, each subarray may be arranged in a predetermined rule on a two-dimensional plane, and the position of each subarray may then be used as a base value for frequency distribution and interference control. In this case, a distance value is set based on the position of the antenna element, and the distance in the x-axis direction

$${d}_{\text{?}}^{\text{?}}$$

$$\text{?} \text{indicates text missing or illegible when filed}$$

may be defined by Equation 1 below.

$${d}_{\text{?}}^{\text{?}} = ( \frac{{M}_{\text{?}} + 1}{2} - {m}_{x} ) {N}_{x} + ( \frac{{N}_{x} + 1}{2} - {n}_{x} ) {d}_{x} \qquad [ Equation 1 ]$$

$$\text{?} \text{indicates text missing or illegible when filed}$$

Here, Mₓ means the number of subarrays in the x-axis direction, Nₓ means the number of antennas in the x-axis direction within each subarray, mₓ means an index of a subarray in the x-axis direction, nₓ means an index of an antenna element in the x-axis direction, and dₓ means spacing between adjacent antennas in an x-axis direction.

In addition, the distance

$${\tilde{d}}_{\text{?}}^{\text{?}}$$

$$\text{?} \text{indicates text missing or illegible when filed}$$

in the y-axis direction may be defined by Equation 2 below.

$${\tilde{d}}_{\text{?}}^{\text{?}} = ( \frac{{M}_{y} + 1}{2} - {m}_{y} ) {N}_{y} + ( \frac{{N}_{y} + 1}{2} - {n}_{y} ) {d}_{y} \qquad [ Equation 2 ]$$

$$\text{?} \text{indicates text missing or illegible when filed}$$

Here, M_{y}, N_{y}, m_{y}, n_{y}, d_{y} also mean the number of subarrays in the y-axis direction, the number of antennas in the y-axis direction within each subarray, an index of a subarray in the y-axis direction, an index of an antenna element in the y-axis direction, and the spacing between adjacent antennas in a y-axis direction, respectively.

In step S120, a transmission frequency may be independently determined for each antenna element included in each subarray based on the position information set in S110. This frequency may be calculated by including a frequency deviation value and may be designed according to a position of a receiver. A transmission frequency offset of each antenna element may be determined based on the set position information.

A frequency offset Λₘ_{ₓ} in the x-axis direction may be set by Equation 3 below.

$${Δ}_{\text{?}} = ( \frac{{M}_{x}}{2} - ( {m}_{\text{?}} - 1 ) - ⌊ \frac{2 ( {m}_{x} - 1 )}{{M}_{x}} ⌋ ) Δ {f}_{\text{?}} \qquad [ Equation 3 ]$$

$$\text{?} \text{indicates text missing or illegible when filed}$$

In this case, Mₓ means the number of subarrays in the x-axis direction, mₓ means the x-axis direction subarray index, └⋅┘ means the floor function that discards the decimal point and leaves only the integer part, and Δfₓ means frequency offset spacing in the x-axis direction.

A frequency offset \tilde{Δ}ₘ_{_{y i}}n the y-axis direction may be set by Equation 4 below.

$${\tilde{Δ}}_{\text{?}} = ( \frac{{M}_{y}}{2} - ( {m}_{y} - 1 ) - ⌊ \frac{2 ( {m}_{y} - 1 )}{{M}_{y}} ⌋ ) Δ {f}_{y} \qquad [ Equation 4 ]$$

$$\text{?} \text{indicates text missing or illegible when filed}$$

In this case, M_{y} means the number of subarrays in the y-axis direction, m_{y} means the y-axis direction subarray index, └⋅┘ means the floor function that discards the decimal point and leaves only the integer part, and Δf_{y} means frequency offset spacing in the y-axis direction.

As a result, the transmission frequency is determined by adding a correction term according to the frequency offset value set according to a position of a subarray in the x-axis direction and a position index of an antenna element in the x-axis direction within the subarray, and a correction term according to the frequency offset value set according to a position of a subarray in the y-axis direction and a position index of a y-axis direction antenna element within the subarray, respectively, based on a reference frequency.

The final transmission frequency of each antenna element is determined by Equation 5 below the following equation.

$${f}_{\text{?}}^{\text{?}} = f \text{?} + {Δ}_{{m}_{\text{?}}} {χ}_{{n}_{\text{?}}} + {\tilde{Δ}}_{{m}_{\text{?}}} {\tilde{χ}}_{{n}_{\text{?}}} \qquad [ Equation 5 ]$$

$$\text{?} \text{indicates text missing or illegible when filed}$$

Here,

$${f}_{\text{?}}^{\text{?}}$$

$$\text{?} \text{indicates text missing or illegible when filed}$$

is a transmission frequency of (nₓ,n_{y})-th antenna element within (mₓ, m_{y})-th subarray, f_{c} is a reference frequency of entire frequency diverse array (FDA), Δₘ_{ₓ} is a unit value of the frequency offset in the x-axis direction set according to the x-axis direction subarray position mₓ, χₙ_{ₓ} is a weighting factor according to the antenna element index within the x-axis subarray, \tilde{Δ}ₘ_{_{y}} is a unit value of the frequency offset in the y-axis direction set according to position of a subarray in the y-axis direction m_{y}, \tilde{χ}ₙ_{_{y}} is a weighting factor according to the antenna element index within the y-axis subarray.
χₙ_{ₓ} and \tilde{χ}ₙ_{_{y}} are normalized indices of antenna elements in the x-axis and y-axis directions, respectively, and defined as Equation 6 and Equation 7 in the horizontal direction and the vertical direction, respectively.

$${χ}_{{n}_{\text{?}}} = \frac{{N}_{x} + 1}{2} - {n}_{\text{?}} \qquad [ Equation 6 ]$$

$${\tilde{χ}}_{{n}_{\text{?}}} = \frac{{N}_{y} + 1}{2} - {n}_{y} \qquad [ Equation 7 ]$$

$$\text{?} \text{indicates text missing or illegible when filed}$$

In step S130, some of the plurality of subarrays may be randomly selected as a first transmission group. The random selection may be changed for each transmission symbol period. The antennas included in the first transmission group may transmit signals in a manner of in a manner of being subjected to precoding so that the phases of the signals are matched at a receiver position. Such a matching signal may allow the receiver to obtain a high gain, thereby enabling stable reception. Considering the difference in signal arrival time from each antenna element for a receiver position, (r,φ,θ), a phase delay may be expressed by Equation 8 below.

$${Υ}_{\text{?}}^{\text{?}} ( r , ϕ , θ ) = {k}_{\text{?}}^{\text{?}} [ r - ( {d}_{\text{?}}^{\text{?}} sin θ cos ϕ + {\tilde{d}}_{\text{?}}^{\text{?}} sin θ cos ϕ ) ] \qquad [ Equation 8 ]$$

$$\text{?} \text{indicates text missing or illegible when filed}$$

Here,

$${Υ}_{\text{?}}^{\text{?}} ( r , ϕ , θ )$$

$$\text{?} \text{indicates text missing or illegible when filed}$$

is a phase delay from a particular antenna element to a receiving point,

$${k}_{\text{?}}^{\text{?}}$$

$$\text{?} \text{indicates text missing or illegible when filed}$$

means the wavenumber corresponding to the center frequency of each antenna element, r is the distance to the receiver, φ is an azimuth angle, θ is an elevation angle, and

$${d}_{\text{?}}^{\text{?}} , {d}_{\text{?}}^{\text{?}}$$

$$\text{?} \text{indicates text missing or illegible when filed}$$

are x-axis and y-axis direction antenna element positions, respectively.

Based on these phases, a precoding weight υₗ(κ) may be set as follows.

$${v}_{l} ( κ ) = \frac{1}{\sqrt{L}} {e}^{j {Υ}_{\text{?}}^{\text{?}} ( {r}_{B} , {ϕ}_{B} , {θ}_{B} )} \qquad [ Equation 9 ]$$

$$\text{?} \text{indicates text missing or illegible when filed}$$

for (mₓ,m_{y}) ∈ first transmission group

Here, υₗ(κ) is a precoding weight applied to l-th antenna belonging to first transmission group in a transmission period κ, κ is an index of transmission period in which the current transmission is performed, L is the number of transmitting antennas or subarrays included in the first transmission group,

$${Υ}_{\text{?}}^{\text{?}} ( {r}_{B} , {ϕ}_{B} , {θ}_{B} )$$

$$\text{?} \text{indicates text missing or illegible when filed}$$

is a phase delay at a receiver position (r_{B},φ_{B},θ_{B}) according to the subarray position (mₓ,m_{y}) and antenna element position (nₓ,n_{y}) within corresponding subarray, mₓ,m_{y} are position indices of subarray arranged in the x-axis and y-axis directions, nₓ,n_{y} are position indices of individual antenna element within each subarray, r_{B} is a range of a receiver, φ_{B} is an azimuth angle of the receiver, θ_{B} and is an elevation angle of the receiver.

This phase design allows the signals of the transmission antennas to be matched and synthesized at the receiver position.

In step S140, the remaining subarrays that are not included in the first transmission group may be selected as the second transmission group. The second transmission group is randomly selected, and some of the subarrays belonging to the second transmission group are randomly selected to apply a phase shift of the transmission signal by π (180 degrees), so that the interference effect is minimized at the receiver position and the interference signal is strengthened at the eavesdropper position. This interference signal may be canceled out at the receiver position and observed as random noise at external positions, which can improve security.

To this end, a phase reversal of π is applied to the antennas belonging to the second transmission group as follows.

$${v}_{l} ( κ ) = \frac{1}{\sqrt{L}} {e}^{j ( {Υ}_{\text{?}}^{\text{?}} ( {r}_{B} , {ϕ}_{B} , {θ}_{B} ) + π )} for ( {m}_{x} , {m}_{y} ) ∈ second transmission group \qquad [ Equation 10 ]$$

$$\text{?} \text{indicates text missing or illegible when filed}$$

Here, υₗ(κ) is a precoding weight applied to l-th antenna belonging to a second transmission group in a transmission period κ, κ is an index of transmission period in which the current transmission is performed, L is the number of transmitting antennas or subarrays included in the second transmission group,

$${Υ}_{\text{?}}^{\text{?}} ( {r}_{B} , {ϕ}_{B} , {θ}_{B} )$$

$$\text{?} \text{indicates text missing or illegible when filed}$$

is a phase delay at the receiver position (r_{B},φ_{B},θ_{B}) according to the subarray position (mₓ,m_{y}) and antenna element position (nₓ,n_{y}) within corresponding subarray, mₓ,m_{y} are position indices of subarray arranged in x-axis and y-axis directions, nₓ,n_{y} are position indices of individual antenna elements within each subarray, r_{B} is a range of a receiver, φ_{B} is an azimuth angle of the receiver, and θ_{B} is an elevation angle of the receiver.

The phase-inverted interference signal is cancelled out by the matching signal, leaving a receiver Bob hardly affected by the interference, whereas the interference pattern is amplified by random phase combination outside the receiver position, making it difficult for an eavesdropper Eve to restore the signal.

Finally, in step S150, an operation of combining the matching signal and interference signal generated in the previous steps S130 and S140, respectively, and generating a final transmission signal to transmit the final transmission signal. The final transmission signal generated at this time is comprised of a composite signal that enables stable reception at the receiver position and induces observation in the form of random interference at the position of an external eavesdropper. The matching signal and the interference signal can be linearly combined and transmitted in a linear combination manner by being synchronized in the same time and frequency band as follows.

The final signal received by the receiver is as follows:

y(r,φ,θ,κ)=\sqrt{P}h*(r,φ,θ)v(κ)s(κ)+ν(κ) [Equation 11]

Here, y(r,φ,θ,κ) is a signal received at a specific point in time κ, P represents the transmission power, h*(r,φ,θ) represents a complex conjugate of a complex channel response vector, v(κ) represents a transmission precoding vector of a κ-th symbol, s(κ) represents data of the κ-th symbol, and ν(κ) represents noise of the κ-th symbol.

Here, a composite radiation pattern including both the matching signal and the interference signal is expressed through the following inner product operation.

$$ℱ ( r , ϕ , θ , κ ) = {h}^{\text{?}} ( r , ϕ , θ ) v ( κ ) = {\sum }_{l = 1}^{L} {h}_{l}^{\text{?}} ( r , ϕ , θ ) {v}_{l} ( κ ) \qquad [ Equation 12 ]$$

$$\text{?} \text{indicates text missing or illegible when filed}$$

Here, [symbol] (r,φ,θ,κ) is the composite beamforming pattern value formed when the κ-th symbol is transmitted, L represents the total number of antenna elements,

$${h}_{l}^{\text{?}} ( r , ϕ , θ )$$

$$\text{?} \text{indicates text missing or illegible when filed}$$

is a complex conjugate of a channel response of an l-th transmitting antenna, and υₗ(κ) is a precoding vector of the l-th transmitting antenna.

That is, the final signal may be formed by multiplying the channel responses of all antenna elements and the beamforming weights and then summing the multiplication results.

Through such a structure, a matched valid signal can be transmitted to the receiver Bob, while the transmission signal may be induced to be transmitted to the eavesdropper Eve as an interference signal from which information cannot be restored. As a result, the transmission system of the present disclosure can enhance information security at the physical layer level.

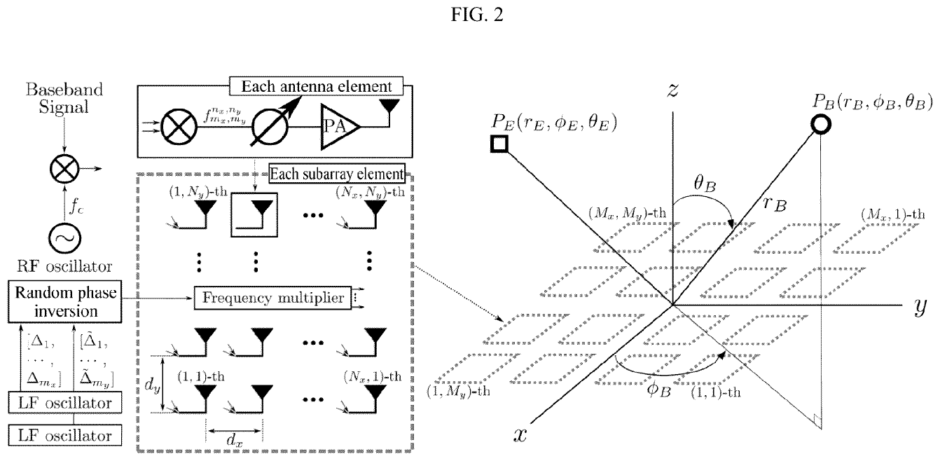

FIG. 2 is a diagram showing a planar frequency diverse array (FDA)-based transmitter configuration according to an embodiment of the present disclosure. In particular, FIG. 2 illustrates a structure of a wireless communication system for enhancing security in the transmission direction based on a multi-antenna transmitter comprised of a plurality of subarrays.

The transmitter may be configured by dividing the entire array into a plurality of subarrays. Each subarray may include Nₓ and N_{y} antenna elements based on the x-axis and y-axis directions, and the frequency offset configuration method between the subarrays is the same, but the frequency offset value applied to each subarray may be set differently. Through this differentiated frequency offset configurations, the subarrays may form different far-field radiation pattern in three-dimensional space.

In the present disclosure, it may be assumed that the position or channel information of the legitimate receiver Bob, which is a transmission target, is known. The transmitter may perform random radiation every time a data symbol is transmitted, and to this end, the transmitter can randomly select a subarray to be used for transmission for each data symbol. In this case, the number of subarrays selected may be preset and fixed as a system parameter.

For the selected subarray, a phase of a precoding vector of the subarray may be flipped by π to perform phase reversal. Through this, the radiation pattern in the side lobe direction may be randomized, and as a result, the transmission signal may be induced to be observed as artificial noise in areas other than the receiver direction.

Since the receiver Bob is located in the main lobe direction, a slight reception gain loss may occur to the receiver Bob, but good reception quality may still be secured for the receiver Bob. On the other hand, since the eavesdropper Eve is located in the side lobe area or in another direction, the reception quality may be degraded by the randomized artificial noise signal for the eavesdropper Eve. Accordingly, the channel capacity difference (secrecy rate) between the receiver Bob and the eavesdropper Eve may be maximized.

In addition, the side lobe suppression power may vary depending on the frequency offset configuration method and frequency offset value applied to each subarray, and the security performance may also vary depending on the number of subarrays selected for random radiation. Therefore, in the present disclosure, a genetic algorithm (GA)-based optimization technique may be applied for optimization of these parameters.

Specifically, when system conditions such as the transmission power, the number of transmission antenna elements, and the position of the eavesdropper are given, the secrecy rate of the entire system may be maximized by performing a genetic algorithm that optimizes the frequency offset value and the random subset size.

The transmitter shown in FIG. 2 may dramatically improve communication security performance through subarray-based nonlinear frequency offset configuration, subarray random selection, phase reversal, and genetic algorithm optimization.

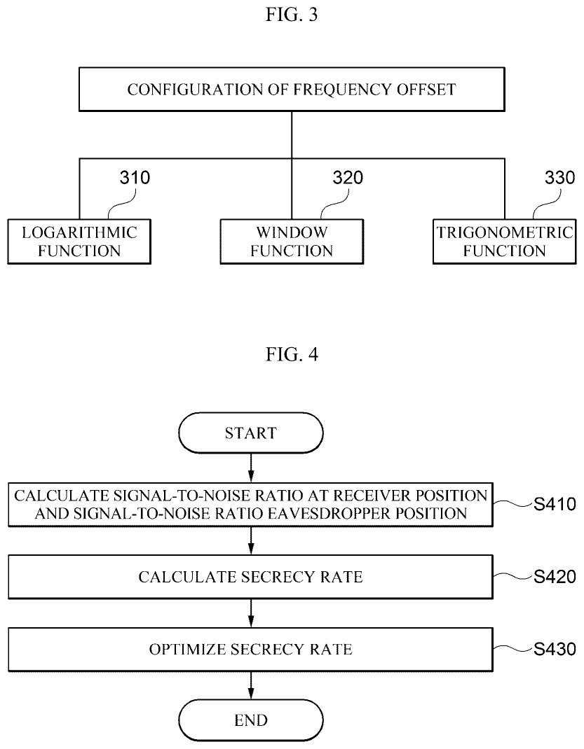

FIG. 3 is a block diagram illustrating a frequency offset configuration method according to an embodiment of the present disclosure, in which the frequency offset is configured based on the position of the subarray, and structurally presents various methods for configuring the frequency offset based on a mathematical function. The various methods are a logarithmic function-based method 310, a window function-based method 320, and a trigonometric function-based method 330 in FIG. 3.

In the logarithmic function-based method 310, the frequency offset is configured based on a logarithmic function. This method may generate a pattern in which the frequency offset size gradually decreases toward the center of the antenna array by assigning weights in the form of a logarithmic function according to indices of the antenna elements within the subarray. Accordingly, the elements located in the center are applied with a relatively high proportion of frequency shift compared to the antenna elements located at the edges of the array, so that the central concentration of the entire radiation pattern may be adjusted. The corresponding equation is as follows.

$${χ}_{\text{?}}^{L} = log ( {N}_{x} + 1 - {n}_{\text{?}} ) , {\tilde{χ}}_{\text{?}}^{L} = log ( {N}_{y} + 1 - {n}_{y} ) \qquad [ Equation 13 ]$$

$$\text{?} \text{indicates text missing or illegible when filed}$$

Here, Nₓ and N_{y} are the number of antenna elements in the x-axis direction and the y-axis direction, respectively, and, nₓ∈{1, 2, . . . , Nₓ} and n_{y}∈{1, 2, . . . , N_{y}} represent antenna indices corresponding to the x-axis direction and the y-axis direction, respectively. This log-based weights can be utilized in a way that is advantageous in assigning higher importance to points closer to the antenna center.

In the window function-based method 320, the frequency offset is configured based on a window function. Specifically, a Hamming window form may be applied to assign a smooth weight to each antenna element within a subarray. This method has the characteristic that the antenna element located in the center has a high weight, and the weight gradually decreases as it goes toward the edge. Through this, the effect of improving the side lobe suppression characteristics can be obtained, and the directionality and spatial concentration of the transmission signal can be controlled in a balanced manner. This method is expressed by Equation 14.

$${χ}_{\text{?}}^{H} = 0.54 - 0.46 cos ( \frac{2 π ( {n}_{x} - 0.5 )}{{N}_{x}} ) \qquad [ Equation 14 ]$$

$${\tilde{χ}}_{\text{?}}^{H} = 0.54 - 0.46 cos ( \frac{2 π ( {n}_{y} - 0.5 )}{{N}_{y}} )$$

$$\text{?} \text{indicates text missing or illegible when filed}$$

In this case, the cos(⋅) term forms a maximum value at the center and a minimum value at both ends, which may maximize the side lobe suppression effect. The method of using the window function is a frequently used method for the design of a traditional finite impulse response (FIR) filter or a fast Fourier transform (FFT)-based signal processing, and the same may be applied to form a smooth decay curve of the array radiation pattern.

In the trigonometric function-based method 330, the frequency offset is configured based on a trigonometric function. The trigonometric function-based method is a method of setting weights by applying the sine function and the cosine function to each bin section according to the position of the antenna element within the subarray. In the trigonometric function-based method, an asymmetric and dynamic weight distribution may be formed in the left-and-right or up-and-down direction based on the center of the array. Through this, the trigonometric function-based method may contribute to the enhancement of communication security performance by concentrating transmission energy in a specific direction or emphasizing randomness. This method expressed as a function in the following form.

$${χ}_{\text{?}}^{P} = \{ \begin{matrix}- sin ( {N}_{x} ( \frac{{N}_{\text{?}} + 1}{2} - {n}_{x} ) ) , & 1 \leq {n}_{x} \leq ⌈ {N}_{x} / 2 ⌉ \\ cos ( 2 {N}_{x} ( \frac{{N}_{\text{?}} + 1}{2} - {n}_{x} ) ) , & ⌈ {N}_{x} / 2 ⌉ < {n}_{x} \leq {N}_{x}\end{matrix} \qquad [ Equation 15 ]$$

$${\tilde{χ}}_{\text{?}}^{P} = \{ \begin{matrix}- sin ( {N}_{y} ( \frac{{N}_{\text{?}} + 1}{2} - {n}_{y} ) ) , & 1 \leq {n}_{y} \leq ⌈ {N}_{y} / 2 ⌉ \\ cos ( 2 {N}_{y} ( \frac{{N}_{\text{?}} + 1}{2} - {n}_{y} ) ) , & ⌈ {N}_{y} / 2 ⌉ < {n}_{y} \leq {N}_{y}\end{matrix}$$

$$\text{?} \text{indicates text missing or illegible when filed}$$

Here, ┌⋅┐ means a ceiling function, which is designed in such a way that the sine and cosine functions are inverted based on the center of the array. It is characterized by generating a nonlinear phase distribution in the entire array, which can induce diversity and irregularity in radiation patterns.

As a result, the three methods shown in FIG. 3 have the characteristics of nonlinear logarithmic-based shaping, window-based regularization shaping, and trigonometric waveform-based random shaping, respectively, and these methods may be usefully utilized for randomized transmission and interference shaping using frequency diversity in a physical layer security system. In addition, these methods enable a flexible design structure that can be dynamically selected according to the desired radiation pattern characteristics when implementing the system.

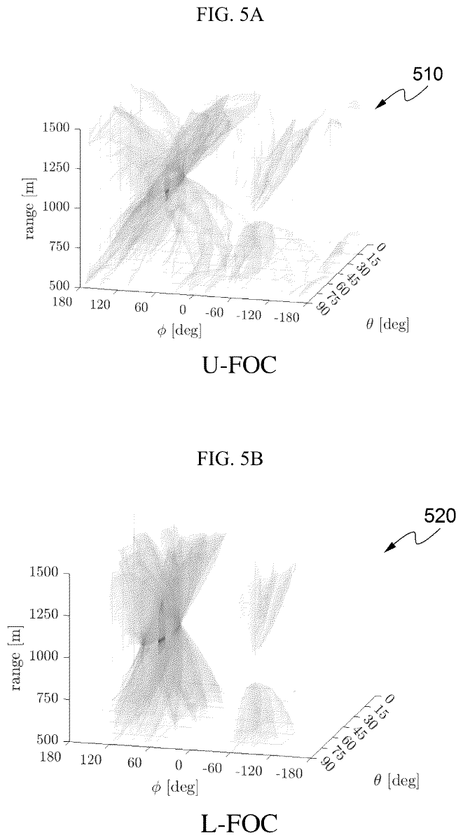

FIG. 4 is a flowchart illustrating a secrecy rate optimization procedure according to an embodiment of the present disclosure. This flowchart includes specific steps for maximizing physical layer security performance by reflecting the channel states of the receiver Bob and the eavesdropper Eve.

First, in step S410, a transmission device may calculate a signal-to-noise ratio (SNR) at each of a receiver position and an eavesdropper position. The signal-to-noise ratio at the position of the receiver Bob is calculated as follows.

$${γ}_{B} = \frac{P {\vert 𝔼 [ ℱ ( {r}_{B} , {ϕ}_{B} , {θ}_{B} , κ ) ] \vert}^{2}}{P \cdot Var [ ℱ ( {r}_{B} , {ϕ}_{B} , {θ}_{B} , κ ) ] + {σ}^{2}} \qquad [ Equation 16 ]$$

Here, P means the transmission power, [symbol] [ [symbol] (r_{B},φ_{B},θ_{B},κ)] represents an average array gain of a transmission signal at a receiver position, Var[ [symbol] (r_{B},φ_{B},θ_{B},κ)] represents an array gain dispersion of the transmission signal at the corresponding position, σ² represents the noise power at a receiving end, and (r_{B},φ_{B},θ_{B}) represents the position of the receiver.

The signal-to-noise ratio at the position of the eavesdropper Eve may also be calculated similarly as follows.

$${γ}_{E} = \frac{P {\vert 𝔼 [ ℱ ( {r}_{E} , {ϕ}_{E} , {θ}_{E} , κ ) ] \vert}^{2}}{P \cdot Var [ ℱ ( {r}_{E} , {ϕ}_{E} , {θ}_{E} , κ ) ] + {σ}^{2}} \qquad [ Equation 17 ]$$

Here, (r_{E},φ_{E},θ_{E}) represent a range, azimuth, and elevation of the eavesdropper, respectively, and other symbols have the same meaning as those described for the receiver.

In addition, the signal-to-noise ratio of the eavesdropper may be expressed as an approximation to simplify complex calculation, and the following approximation may be used.

$${γ}_{E} \approx {\tilde{γ}}_{E} = \frac{( M - 1 ) {( 2 {M}_{\text{?}} - M )}^{2}}{4 {M}_{\text{?}} ( M - {M}_{\text{?}} )} \cdot \frac{{\vert Λ ( {r}_{E} , {ϕ}_{E} , {θ}_{E} ) \vert}^{2}}{M \overline{Λ} ( {r}_{E} , {ϕ}_{E} , {θ}_{E} ) - {\vert Λ ( {r}_{E} , {ϕ}_{E} , {θ}_{E} ) \vert}^{2}} \qquad [ Equation 18 ]$$

$$\text{?} \text{indicates text missing or illegible when filed}$$

Here, M means the number of total subarrays, Mₛ means the number of randomly selected subarrays, Λ(r_{E},φ_{E},θ_{E}) means the linear combination of complex array responses at the eavesdropper position, and Λ̅(r_{E},φ_{E},θ_{E}) means the average power of the array responses.

Subsequently, in step S420, the secrecy rate may be calculated based on the signal-to-noise ratio of the receiver and the eavesdropper. The secrecy rate is defined as a positive part of the difference in channel capacity between the receiver and the eavesdropper, and may be expressed as follows.

η=[ log₂(1+γ_{B})−log₂(1+γ_{E})]⁺ [Equation 19]

Here, η means the secrecy rate, and [x]⁺ means an operation that returns 0 if x is a negative number and maintains the value as it is if x is a positive number.

Through this type of secrecy rate calculation, the receiver should satisfy the condition that the receiver has a higher ability to recover information than the eavesdropper in order for the communication to be secure.)

Finally, in step S430, an optimization process that maximizes the secrecy rate may be performed. In this case, the secrecy rate may be specifically calculated as follows according to the transmission power, the number of transmission antennas, the number of random subarrays Mₛ, and the frequency offset parameter.

$$η = {[ {log}_{2} ( 1 + \frac{PN}{{σ}^{2} {r}_{B}^{2}} \cdot \frac{{( 2 {M}_{\text{?}} - M )}^{2}}{M} ) - {log}_{2} ( 1 + \frac{P {\vert \frac{1}{{r}_{E} \sqrt{L}} \frac{2 {M}_{\text{?}} - M}{M} Λ ( {r}_{E} , {ϕ}_{E} , {θ}_{E} ) \vert}^{2}}{\begin{matrix}\frac{4 P}{{r}_{E}^{2} L} \frac{{M}_{\text{?}} ( M - {M}_{\text{?}} )}{M ( M - 1 )} [ \overline{Λ} ( {r}_{E} , {ϕ}_{E} , {θ}_{E} ) - \\ \frac{1}{M} {\vert Λ ( {r}_{E} , {ϕ}_{E} , {θ}_{E} ) \vert}^{2} ] + {σ}^{2}\end{matrix}} ) ]}^{+} \qquad [ Equation 20 ]$$

$$\text{?} \text{indicates text missing or illegible when filed}$$

Here, η is a secrecy rate, which means a secure transmission rate at which the receiver can restore information and the eavesdropper cannot restore information, P means transmission power, N means the number of antennas included in the receiving device of the receiver, σ² means the power of noise, r^{B} means the distance from the transmission antenna to the receiver, r^{E} means the distance between the transmission antenna and the eavesdropper, M means the number of total subarrays (or transmission antennas), Mₛ means the number of subarrays included in the first transmission group (matching signal group), L means a normalization coefficient considered when combining matching signals, |Λ|² means the square size of the sum of the phase-aligned signals at the receiving position, Λ̅ means the sum of the power of all transmission signals arriving at the receiving position, and [⋅]⁺ means a positive part that returns 0 if the value in the parentheses is less than 0, and returns the value as it is if it is greater than or equal to 0.

In addition, the secrecy rate may be guaranteed to satisfy the following optimization condition under certain conditions.

$$η > {[ {log}_{2} ( 1 + \frac{PN}{{σ}^{2} {r}_{B}^{2}} \cdot \frac{{( 2 {M}_{\text{?}} - M )}^{2}}{M} ) - {log}_{2} ( 1 + \frac{( M - 1 ) {( 2 {M}_{\text{?}} - M )}^{2} {\vert Λ ( {r}_{E} , {ϕ}_{E} , {θ}_{E} ) \vert}^{2}}{\begin{matrix}4 {M}_{\text{?}} ( M - {M}_{\text{?}} ) ( M \overline{Λ} ( {r}_{E} , {ϕ}_{E} , {θ}_{E} ) - \\ {\vert Λ ( {r}_{E} , {ϕ}_{E} , {θ}_{E} ) \vert}^{2} )\end{matrix}} ) ]}^{+} \qquad [ Equation 21 ]$$

$$\text{?} \text{indicates text missing or illegible when filed}$$

Through this optimization process, the transmitter can transmit the signal to the receiver with high reliability, while creating a condition in which information recovery is virtually impossible for an eavesdropper, thereby maximizing the efficiency of the physical layer-based secure communication system.

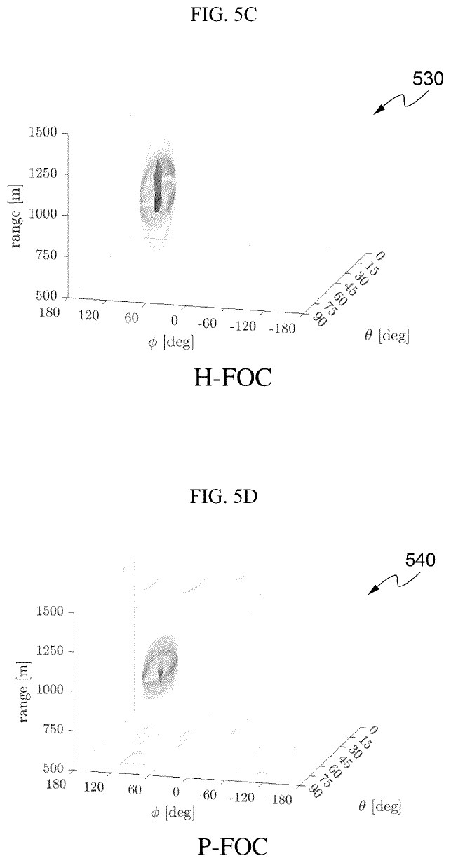

FIGS. 5A to 5D are diagrams showing a long-range radiation pattern formed according to various frequency offset configuration methods according to an embodiment of the present disclosure. In particular, FIGS. 5A to 5D visually shows the radiation pattern distribution in a three-dimensional space when uniform frequency offset configuration (U-FOC) (FIG. 5A), logarithmic frequency offset configuration (L-FOC) (FIG. 5B), hamming window-based frequency offset configuration (H-FOC) (FIG. 5C), piecewise trigonometric frequency offset configuration (P-FOC) (FIG. 5D) are applied, respectively.

First, the uniform frequency offset configuration (U-FOC) 510 shown in FIG. 5A is a method of uniformly assigning a frequency offset to the entire subarray, and has the advantages of being simple to implement and intuitive, but may be somewhat vulnerable in terms of communication security because side lobes are widely spread in the radiation pattern. Since the transmission signal is strongly radiated in directions other than a receiving target, there is a possibility of unnecessary information leakage.

Next, the logarithmic frequency offset configuration (L-FOC) 520 shown in FIG. 5B is a method of increasing the frequency offset value in the form of a logarithmic function according to the position of the subarray. Through this, a relatively small frequency change is applied near the center and a large frequency change is applied toward the edges, and thus the effect of somewhat suppressing the side lobes in the radiation pattern may be obtained. As a result, the energy concentration toward a communication target is improved, and thus the security performance may be improved.

The Hamming Window-based Frequency Offset configuration (H-FOC) 530 shown in FIG. 5C is a method of applying a frequency offset based on a Hamming window function, and has the characteristics of maximizing the energy concentrated on the main lobe and effectively suppressing the surrounding side lobes. As can be seen in the radiation pattern, the energy is concentrated on the main lobe area and the energy is significantly weakened in the side lobes, which greatly reduces signal emission other than in the direction of the receiver, thereby capable of improving both communication security and reception quality.

Finally, the piecewise trigonometric function-based frequency offset configuration (P-FOC) 540 shown in FIG. 5D is a method of nonlinearly applying a frequency offset based on a trigonometric function according to the position of the subarray. By applying different frequency offset patterns to the subarrays near the center and near the edges, the main lobe is formed more clearly and precisely, and the side lobes have irregular and dispersed shapes, which can maximize the difference in reception quality between the receiver and the eavesdropper.

In this way, in the present disclosure, the entire system can be effectively improved by controlling the radiation pattern of the transmitter through various frequency offset configuration techniques, ensuring high signal quality to the legitimate receiver, which is the communication target, and allowing the signal to be transmitted to the eavesdropper in the form of randomized artificial noise. In particular, the Hamming window-based frequency offset configuration and the piecewise trigonometric function-based frequency offset configuration strongly suppress unnecessary radiation in directions other than the receiver, which can be very advantageous in a wireless communication environment where security is important.

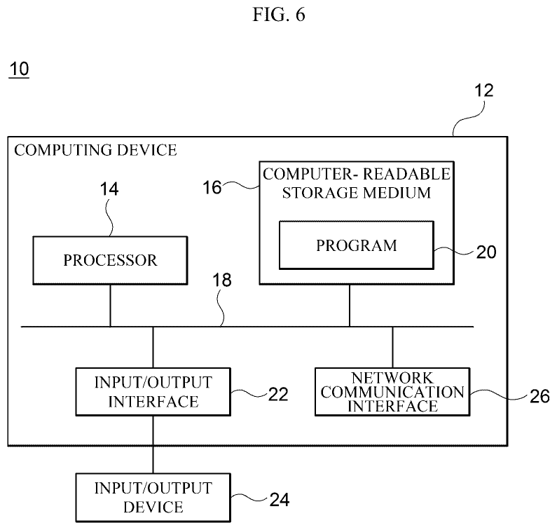

FIG. 6 is a block diagram showing the configuration of a computing device for secure wireless signal transmission using a subarray-based frequency diverse array according to an embodiment. In the illustrated embodiment, each component may have different functions and capabilities other than those described below, and additional components may be included in addition to those described below.

An illustrated computing environment 10 includes a computing device 12. In an embodiment, the computing device 12 may perform the secure wireless signal transmission method using the subarray-based frequency diverse array described with reference to FIGS. 1 to 5D.

The computing device 12 includes at least one processor 14, a computer-readable storage medium 16, and a communication bus 18. The processor 14 may cause the computing device 12 to operate according to the exemplary embodiment described below. For example, the processor 14 may execute one or more programs stored in the computer-readable storage medium 16. The one or more programs may include one or more computer-executable instructions, and the computer-executable instructions, when executed by the processor 14, may be configured to cause the computing device 12 to perform operations according to the exemplary embodiment.

The computer-readable storage medium 16 is configured to store computer-executable instructions or program code, program data, and/or other suitable forms of information. A program 20 stored in the computer-readable storage medium 16 includes a set of instructions executable by the processor 14. In an embodiment, the computer-readable storage medium 16 may be a memory (a volatile memory such as random access memory, a nonvolatile memory, or a suitable combination thereof), one or more magnetic disk storage devices, optical disk storage devices, flash memory devices, or other forms of storage media that are accessible by the computing device 12 and capable of storing desired information, or a suitable combination thereof.

The communication bus 18 interconnects various other components of the computing device 12, including the processor 14 and the computer-readable storage medium 16.

The computing device 12 may also include one or more input/output interfaces 22 that provide interfaces for one or more input/output devices 24 and one or more network communication interfaces 26. The input/output interfaces 22 and the network communication interfaces 26 are connected to the communication bus 18. The input/output devices 24 may be connected to other components of the computing device 12 via the input/output interfaces 22. Exemplary input/output devices 24 may include input devices such as pointing devices (e.g., mouses or trackpads), keyboards, touch input devices (e.g., touchpad or touchscreen), voice or sound input devices, input devices such as various types of sensor devices and/or photographing devices, and/or output devices such as display devices, printers, speakers, and/or network cards. Exemplary input/output devices 24 may be included within the computing device 12 as a component that constitutes the computing device 12, or may be connected to the computing device 12 as a separate device distinct from the computing device 12.

The secure wireless signal transmission system using the subarray-based frequency diverse array described through FIGS. 1 to 6 may also be implemented in the form of a computer program stored in a computer-readable recording medium executed by a computer or a recording medium including instructions executable by the computer. In addition, the secure wireless signal transmission method using the subarray-based frequency diverse array described through FIGS. 1 to 6 may also be implemented in the form of a computer program stored in the computer-readable recording medium executed by the computer.

The computer-readable recording medium may be any available medium that can be accessed by a computer, and includes both volatile and nonvolatile media and removable and non-removable media. In addition, the computer-readable recording medium may include a computer storage medium. The computer storage medium includes both volatile and nonvolatile media and removable and non-removable media implemented in any method or technology for storing information such as computer-readable instructions, data structures, program modules, or other data.

Examples of program instructions include not only machine language codes such as those generated by a compiler, but also high-level language codes that can be executed by a computer using an interpreter, etc. The hardware device may be configured to operate as one or more software modules to perform processing according to the present disclosure, and vice versa.

According to an embodiment, eavesdropping can be effectively prevented by setting some of the plurality of subarrays as a first transmission group and transmitting a matching signal which is phase-matched at a position of a receiver position, and setting the remaining subarrays as a second transmission group and transmitting an interference signal such that the interference signal is canceled at the position of a receiver and random interference occurs at a position of an eavesdropper. In addition, the reliability and security of the wireless communication system can be improved by optimizing transmission parameters to maximize a secrecy rate, and high security and communication performance can be secured simultaneously under various reception conditions through a plurality of subarrays and frequency offset configuration.

The embodiments of the present disclosure described above is for illustrative purposes only, and those skilled in the art will understand that the embodiments may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed entities may be implemented in a combined manner.

Although representative embodiments of the present disclosure have been described in detail above, those skilled in the art will understand that various modifications may be made to the above-described embodiments without departing from the scope of the present disclosure. Therefore, the scope of the rights of the present disclosure should not be limited to the described embodiments, but should be determined by the claims described below as well as equivalents of the claims.

What is claimed is:

1. A method for wireless signal transmission using a subarray-based frequency diverse array, the method comprising:
configuring a frequency offset for each of a plurality of subarrays based on a reference frequency;
determining a transmission frequency for a plurality of antenna elements included in each of the subarrays based on the frequency offset;
setting some of the plurality of subarrays as a first transmission group and transmitting a matching signal so that phases of signals of the subarrays included in the first transmission group are matched at a position of a receiver;
setting the remaining subarrays not included in the first transmission group among the plurality of subarrays as a second transmission group and transmitting an interference signal so that signals of the subarrays included in the second transmission group induce a random interference effect at a position of an eavesdropper; and
combining the matching signal and the interference signal and transmitting the combined signal to a terminal of the receiver.

2. The method of claim 1, wherein the subarray is comprised of a plurality of antenna blocks arranged in a grid shape in the x-axis and y-axis directions on a two-dimensional plane.

3. The method of claim 1, wherein the frequency offset is configured based on a position of the subarray, and
the configuring of the frequency offset follows a distribution of at least one of a logarithmic function, a window function, or a trigonometric function among non-uniform frequency offset configuration methods.

4. The method of claim 1, wherein the transmission frequency is determined by adding a correction term according to the frequency offset value set according to a position of a subarray in the x-axis direction and a position index of an antenna element in the x-axis direction within the subarray, and a correction term according to the frequency offset value set according to a position of a subarray in the y-axis direction and a position index of a y-axis direction antenna element within the subarray, respectively, based on the reference frequency.

5. The method of claim 4, wherein the transmission frequency is determined by Equation below:
$${f}_{\text{?}}^{\text{?}} = {f}_{\text{?}} + {Δ}_{\text{?}} {χ}_{\text{?}} + {\tilde{Δ}}_{\text{?}} {\tilde{χ}}_{\text{?}} \qquad [ Equation ]$$
$$\text{?} \text{indicates text missing or illegible when filed}$$
wherein
$${f}_{\text{?}}^{\text{?}}$$
$$\text{?} \text{indicates text missing or illegible when filed}$$
is a transmission frequency of (nₓ,n_{y})-th antenna element within (mₓ,m_{y})-th subarray;
f_{c} is a reference frequency of entire frequency diverse array (FDA);
Δₘ_{ₓ} is a unit value of x-direction frequency offset set according to x-axis direction subarray position mₓ;
χₙ_{ₓ} is a position index of x-axis direction antenna element within subarray;
\tilde{Δ}ₘ_{_{y}} is a unit value of y-direction frequency offset set according to position of subarray in the y-axis direction; and
\tilde{χ}ₙ_{_{y}} is a position index of y-axis direction antenna element within subarray.

6. The method of claim 1, wherein the first transmission group is subjected to precoding so that phases are matched at the position of the receiver, and
the second transmission group is set to transmit the interference signal.

7. The method of claim 1, wherein the antennas of the first transmission group are randomly selected for each signal cycle, and
the antennas of the first transmission group are subjected to precoding so that phases are aligned at the position of the receiver.

8. The method of claim 1, wherein the transmission signal is set with a precoding weight for each transmission period corresponding to the position of the receiver for each of the plurality of antenna elements constituting the subarray, for each of the subarrays included in the first transmission group and the subarrays included in the second transmission group, and
the precoding weight is set to reflect a phase delay based on a spatial position of each antenna element and a range, azimuth, and elevation of the receiver.

9. The method of claim 8, wherein the subarray included in the first transmission group is subjected to precoding so that phases are matched at the position of the receiver for each of the antenna elements constituting the subarray, and
the precoding weight applied to the antenna element is set according to Equation below:
$${v}_{l} ( κ ) = \frac{1}{\sqrt{L}} {e}^{j {Υ}_{\text{?}}^{\text{?}} ( \text{?} )} for ( {m}_{\text{?}} , {m}_{\text{?}} ) ∈ first transmission group \qquad [ Equation ]$$
$$\text{?} \text{indicates text missing or illegible when filed}$$
wherein υₗ(κ) is a precoding weight applied to l-th antenna belonging to first transmission group in transmission period κ;
κ is an index of transmission period in which the current transmission is performed;
L is a number of transmitting antennas or subarrays included in first transmission group;
$${ϒ}_{\text{?}}^{\text{?}} ( {r}_{B} , {ϕ}_{B} , {θ}_{B} )$$
$$\text{?} \text{indicates text missing or illegible when filed}$$
is a phase delay at receiver position (r_{B},φ_{B},θ_{B}) according to the subarray position (mₓ,m_{y}) and antenna element position (nₓ,n_{y}) within corresponding subarray;
mₓ,m_{y} is a position indices of subarrays arranged in x-axis and y-axis directions;
nₓ,n_{y} is a position indices of individual antenna elements within each subarray;
r_{B} is a range coordinate of receiver;
φ_{B} is an azimuth angle of receiver; and
θ_{B} is an elevation angle of receiver.

10. The method of claim 8, wherein the subarray included in the second transmission group is subjected to precoding so that the phase is inverted by π is cancelled out by the matching signal for each antenna element constituting the subarray, and
the precoding weight applied to the subarray is set according to Equation below:
$${v}_{l} ( κ ) = \frac{1}{\sqrt{L}} {e}^{j {Υ}_{\text{?}}^{\text{?}} ( \text{?} )} for ( {m}_{\text{?}} , {m}_{\text{?}} ) ∈ second transmission group \qquad [ Equation ]$$
$$\text{?} \text{indicates text missing or illegible when filed}$$
where υₗ(κ) is a precoding weight applied to l-th antenna belonging to second transmission group in transmission period κ;
κ is an index of transmission period in which the current transmission is performed;
L is a number of transmitting antennas or subarrays included in second transmission group;
$${ϒ}_{\text{?}}^{\text{?}} ( {r}_{B} , {ϕ}_{B} , {θ}_{B} )$$
$$\text{?} \text{indicates text missing or illegible when filed}$$
is a phase delay at receiver position (r_{B},φ_{B},θ_{B}) according to the subarray position (mₓ,m_{y}) and antenna element position (nₓ,n_{y}) within corresponding subarray;
mₓ,m_{y} is a position indices of subarrays arranged in x-axis and y-axis directions;
nₓ,n_{y} is a position indices of individual antenna elements within each subarray;
r_{B} is a range coordinate of receiver;
φ_{B} is an azimuth angle of receiver; and
θ_{B} is an elevation angle of receiver.

11. The method of claim 1, wherein the matching signal and the interference signal are synchronized in the same time and frequency band and transmitted in a linear combination manner.

12. The method of claim 1, wherein a secrecy rate is calculated based on a signal-to-noise ratio of the position of the receiver and ae signal-to-noise ratio of the position of an eavesdropper, and
transmission parameters are adjusted so that the secrecy rate is maximized.

13. The method of claim 12, wherein the secrecy rate is calculated by Equation below:
η=[ log₂(1+γ_{B})−log₂(1+γ_{E})]⁺ [Equation]
wherein η is a secrecy rate, which represents secure transmission rate at which receiver can recover information and eavesdropper cannot recover information;
γ_{B} is a received signal-to-noise ratio (SNR) or signal-to-interference-noise ratio (SINR) of receiver;
γ_{E} is a received signal-to-noise ratio (SNR) or signal-to-interference-noise ratio (SINR) of eavesdropper; and
[⋅]⁺ is a positive part, which returns 0 if value in square brackets is less than 0, and returns value as is if it is greater than or equal to 0.

14. The method of claim 12, wherein a combination of the frequency offset value and antenna selection of the subarray is optimized so that the secret rate is maximized based on Equation below:
$$η = {[ {log}_{2} ( 1 + \frac{PN}{{σ}^{2} {r}_{B}^{2}} \cdot \frac{{( 2 {M}_{\text{?}} - M )}^{2}}{M} ) - {log}_{2} ( 1 + \frac{\frac{P}{\text{?} \sqrt{L}} \cdot \frac{2 {M}_{\text{?}} - M}{M} \cdot {\vert Λ \vert}^{2}}{\frac{4 P}{\text{?} L} \cdot \frac{{M}_{\text{?}} ( M - {M}_{\text{?}} )}{M ( M - 1 )} ( \overline{Λ} - \frac{1}{M} {\vert Λ \vert}^{2} ) + {σ}^{2}} ) ]}^{+} \qquad [ Equation ]$$
$$\text{?} \text{indicates text missing or illegible when filed}$$
where η is a secrecy rate, which represents secure transmission rate at which receiver can recover information and eavesdropper cannot recover information
P is a transmission power;
N is a number of antennas included in receiving device of receiver;
σ² is a power of background noise;
r_{B} is a distance from transmitting antenna to receiver;
r_{E} is a distance from transmitting antenna to eavesdropper;
M is a number of total subarrays or transmitting antennas;
Mₓ is a number of subarrays included in first transmission group (matching signal group);
L is a normalization factor considered when combining matching signals;

|Λ|² is a magnitude of square of sum of phase-aligned signals at receiving position;
Λ̅ is a total sum of power of all transmission signals arriving at receiving position; and
[⋅]⁺ is a positive part, which returns 0 if value in square brackets is less than 0, and returns value as is if it is greater than or equal to 0.

15. A computing device comprising:
a plurality of subarrays arranged in a grid shape in the x-axis and y-axis directions on a two-dimensional plane, each subarray being comprised of antenna blocks arranged in a grid shape in the x-axis and y-axis directions on a two-dimensional plane;
a processor; and
a memory storing one or more programs executed by the processor,
wherein the processor is configured to perform:
an operation of configuring a frequency offset for each of the plurality of subarrays based on a reference frequency;
an operation of determining, for a plurality of antenna elements included in each of the subarrays, a transmission frequency of the antenna element based on the frequency offset;
an operation of setting some of the plurality of antennas as a first transmission group and transmitting a matching signal so that a phase of a signal of the antenna included in the first transmission group is matched at a position of a receiver;
an operation of setting the remaining antennas not included in the first transmission group among the plurality of subarrays as a second transmission group and transmitting an interference signal so that a signal of the antenna included in the second transmission group induces a random interference effect at a position of an eavesdropper; and
an operation of combining the matching signal and the interference signal and transmitting the combined signal to a terminal of the receiver.

16. A computer program stored in a non-transitory computer readable storage medium, wherein the computer program includes one or more instructions, and the instructions, when executed by a computing device including one or more processors, cause the computing device to perform:
configuring a frequency offset for each of a plurality of subarrays based on a reference frequency;
determining, for a plurality of antenna elements included in each of the subarrays, a transmission frequency of the antenna element based on the frequency offset;
setting some of the plurality of antennas as a first transmission group and transmitting a matching signal so that a phase of a signal of the antenna included in the first transmission group are matched at a position of a receiver;
setting the remaining antennas not included in the first transmission group among the plurality of subarrays as a second transmission group and transmitting an interference signal so that a signal of the antenna included in the second transmission group induces a random interference effect at a position of an eavesdropper; and
combining the matching signal and the interference signal and transmitting the combined signal to a terminal of the receiver.
